(19) United States
(12) Patent Application Publication
(10) Pub. No.: US 2015/0347699 A1
(43) Pub. Date: Dec. 3, 2015

(54) Actionability framework for genomic biomarker

(71) Applicant: CollabRx, Inc., San Francisco, CA (US)

(72) Inventors: Smruti J. Vidwans, Menlo Park, CA (US); Michelle Turski, San Francisco, CA (US); Randy Gobbel, Brisbane, CA (US); Lisa Y. van Diggelen, San Francisco, CA (US)

(21) Appl. No.: 14/730,228

(22) Filed: Jun. 3, 2015

Related U.S. Application Data
(60) Provisional application No. 62/006,897, filed on Jun. 3, 2014.

(51) Int. Cl. G06F 19/00

(52) U.S. Cl. CPC G06F 19/345

(57) ABSTRACT

An evidence-based computerized method for forming treatment plans can utilize an actionability framework, which can include a basis of actionability and a rationale for actionability for biomarkers. Treatment rules derived from data in literature, such as from clinical trials, case studies, research and published literature, can allow the method to form treatment plans with support reasoning and citations, similar to those of medical professionals. Thus the treatment plans proposed by the evidence-based treatment process can survive the inspection and scrutiny of treating physicians due to the available and cited support documents.

This patent application claims priority from U.S. provisional patent application Ser. No. 62/006,897, filed on Jun. 3, 2014, entitled “A framework for genomic biomarker actionability and its use in clinical decision-making”.

The invention is generally related to healthcare, and more specifically, to systems and methods for determining therapeutic treatment plans for patients.

### BACKGROUND

Over the last decade, there has been a breathtaking fall in the cost of genomics, accompanied by a precipitous rise in the efficiency of the technology that enables rapid sequencing of human genomes. As a result, biomarkers, especially those representing genomic alterations, are becoming increasingly vital to the classification and treatment of cancer. Biomarkers can be defined as measurable molecular or cellular elements linked to a health outcome or state; they can be functionally important in tumors (“oncogenic drivers”) or may be differentially expressed in the malignant versus normal tissue without functional impact (“passengers”).

Diagnostic laboratories around the world are now offering tests that sequence either full exomes or gene panels in cancer samples. It is expected that, in the near future, more clinical-grade transcriptomic and proteomic tests will also become available. While genomics have traditionally been performed for research purposes, in the United States, tests performed under the auspices of the Clinical Laboratory Improvement Amendments (CLIA) can be utilized to inform patient care; currently, a variety of genomic tests, from single gene appraisal to multi-panel tests on anywhere from about 10 to over 400 genes1, full exomic sequencing2, and transcriptomics3 are obtainable from CLIA-certified laboratories. The hope is that patients can be matched to approved, targeted therapies or clinical trials with investigational targeted therapies on the basis of the molecular profiles of their cancer. However, our understanding of the way in which biomarkers defined by genomics are predictive of therapeutic response lags behind the widespread availability of next generation sequencing (NGS) and other diagnostic tests and the pace of development of targeted therapies.

### SUMMARY OF THE EMBODIMENTS

In some embodiments, the present invention discloses a framework for a rule-based treatment model, together with a formation of rules to be used in the model. The framework can include a basis for actionability and a rationale for the actionability. The framework can be used for the clinical actionability of biomarkers that can be used to define treatment strategies as well as aid in identifying clinical research strategies for diverse cancers. The actionability framework can be used in clinical decision making.

The basis for actionability can include literature data to support a plan of action. For example, in the area of biomarkers used in cancer treatment, the biomarkers can be classified as having or not having a function directly important to tumor pathogenesis. The having biomarkers can have a basis of actionability, with literature data served as evidence for selecting the biomarkers.

The rationale for the actionability can include classifying or ranking the treatment plans according to the levels of support provided by the evidence. The actionability assessment results from existing data can have varying levels of support for classification and ranking. For example, in the area of biomarkers used in cancer treatment, the biomarkers having approved drugs with companion diagnostic and the biomarkers for which therapeutic approaches are outlined in treatment guidelines such as in FDA and NCCN guidelines can have the highest level of support for their actionability, as compared to biomarkers that have clinical evidence indicating responsiveness to one or more drug classes, biomarkers used in clinical trials, biomarkers having pre-clinical evidence, and biomarkers having evidence in hereditary (genetic) disease with possible extrapolation to malignancy.

### BRIEF DESCRIPTION OF THE DRAWINGS

FIG. 1 illustrates an example of a methodology for an evidence-based treatment model according to some embodiments.

FIG. 2 illustrates an example of a methodology for a rule based treatment model according to some embodiments.

FIG. 3 illustrates an example of a flowchart for a method for formulating treatment plans used in treating a disease such as cancer.

FIG. 4 illustrates a flowchart for a method for formulating treatment plans, for example, used in treating a disease such as cancer.

FIG. 5 illustrates a flowchart for a method for formulating treatment plans, for example, for use in treating a disease such as cancer.

FIG. 6 illustrates an example of a missing logic for a rule based treatment model according to some embodiments.

FIG. 7 illustrates an example of a generation of hypothetical study or a virtual patient according to some embodiments.

FIG. 8 illustrates an example of a hypothetical study and a virtual patient according to some embodiments.

FIG. 9 illustrates an example of a treatment model according to some embodiments.

FIG. 10 illustrates an example of a flow chart for generating a treatment model according to some embodiments.

FIGS. 11A and 11B illustrate examples of a flow chart for generating hypothetical studies, virtual patients, or expert systems according to some embodiments.

FIG. 12 illustrates a computing environment according to some embodiments.

FIG. 13 is a schematic block diagram of a sample computing environment 1300 with which the present invention can interact.

### DETAILED DESCRIPTION OF THE EMBODIMENTS

In some embodiments, the present invention discloses methods and systems for an evidence-based treatment process, which can provide possible treatment plans for patients based on evidence compiled from a range and variety of sources. The proposed treatment plans can be based on clinical trials, case studies, research, and published literature, among other sources, and thus can be traced to existing support documents. For example, the available data from the compiled sources can be used as inputs to form rules correlating the symptoms and conditions of a patient with the treatment plans.

The evidence-based treatment process can have the same validity as those of medical professionals. The evidence-based treatment process can have advantages over other treatment processes based on more conventionally implemented statistical analysis methods, suggestive proposals, or projection evaluations. The treatment plans proposed by the evidence-based treatment process can survive the inspection and scrutinization of treating physicians due to the available and cited support documents.

In some embodiments, the present invention discloses a computerized method for forming treatment plans for a disease, such as a cancer, that can have a same validity as treatment plans proposed by treating physicians. The computerized treatment plans can be complete and up-to-date since the treatment plans can be derived from a database that includes an up-to-date collection of information related to the disease. Thus, in some embodiments, the computerized treatment plans can be the same as the plans proposed by a group of physician experts, who have great knowledge about the disease.

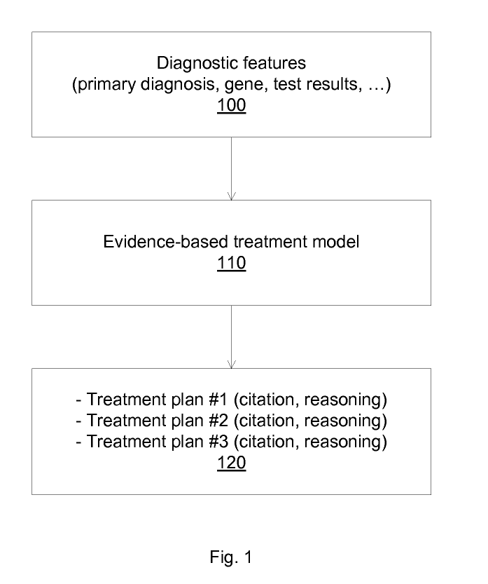

FIG. 1 illustrates an example of a methodology for an evidence-based treatment model according to some embodiments. Module 100 gathers diagnostic features from a patient, including primary diagnosis, genetic analysis, and laboratory test results, among other characteristics of the patient. The diagnostic features can be provided to an evidence-based treatment model 110, which can be a data processing system running an algorithm. The model 110 can process the diagnostic feature data, and generate one or more treatment plans 120, after consulting the database containing all medical information, such as data from clinical trials, case studies, research and published literature, as well as data from other sources. In addition, the model 110 can include, with each treatment plan, the reason for forming the treatment plan together with the one or more citations. In such cases, the citations could include data from the database that can be used to support the rationale for a proposed treatment plan. A successful clinical trial for a similar case is an example of such a citation for a proposed treatment plan. The data from the clinical trial can be included as the citation, or as part of the citation, for the proposed treatment plan.

Thus, treatment plans proposed by the present evidence-based treatment models can be reviewed and assessed by a treating physician using the reasons and citations obtained from the database.

In some embodiments, the methods can incorporate publicly-available information relating to particular diseases to generate rules for the determination of treatment plans based on patient information. For example, patients matching criteria of complete clinical trials can be presented with similar drugs or treatment plans that were demonstrated to have been successful in the clinical trials.

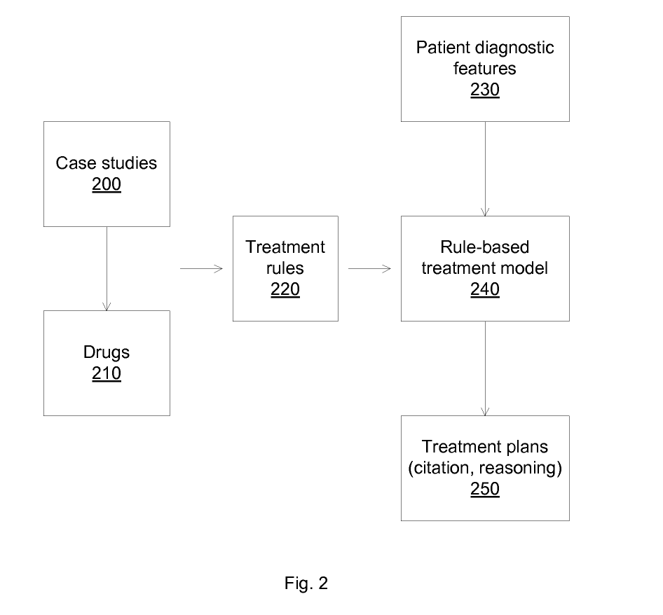

FIG. 2 illustrates an example of a methodology for a rule based treatment model according to some embodiments. Data from literature can be processed to form treatment rules 220 for a rule-based treatment model 240. Since the rules are based on actual and existing data, the treatment model can be considered as an evidence-based treatment model. Data from literature can include data from clinical trials, case studies, research, and published literature, among others. For example, case studies 200 for a disease can be considered, with drugs 210 developed with good results. This data can be used as a treatment rule for the model treatment 240.

The treatment model 240 can be used to generate treatment plans for patients. For example, diagnostic data 230 from a patient can be collected and fed to the treatment model 240. The diagnostic data 230 can be used as input for the treatment model 240 to form treatment plans 250. For example, the diagnostic data can be compared with the treatment rules for cases with similar or exact matching characteristics. If one or more matching cases are found, the results can be used to formulate a treatment plan for the patient. The output of the treatment model can include the evidence from the database, such as the citation from the literature, to support the treatment decision from the formulated treatment plan.

In some embodiments, the present invention discloses a framework for a rule-based treatment model, together with a formation of rules to be used in the model. The framework can include a basis for actionability and a rationale for the actionability. The framework can be used for the clinical actionability of biomarkers that can be used to define treatment strategies as well as to aid in identifying clinical research strategies for diverse cancers. The actionability framework can be used in clinical decision-making.

The basis for actionability can include literature data to support a plan of action. For example, in the area of biomarkers used in cancer treatment, the biomarkers can be classified as having or not having a function directly important to tumor pathogenesis. The having biomarkers can have a basis of actionability, with literature data serving as evidence for selecting the biomarkers.

The rationale for the actionability can include classifying or ranking the treatment plans according to the levels of support provided by the evidence. For example, in the area of biomarkers used in cancer treatment, the biomarkers having approved drugs with companion diagnostic and the biomarkers for which therapeutic approaches are outlined in treatment guidelines such as in FDA and NCCN guidelines can have the highest level of support for their actionability, as compared to biomarkers that have clinical evidence indicating responsiveness to one or more drug classes, biomarkers used in clinical trials, biomarkers having pre-clinical evidence, and biomarkers having evidence in hereditary (genetic) disease with possible extrapolation to malignancy.

In some embodiments, the present invention discloses methods, and data processing systems to perform the methods, for treating diseases such as cancer, including proposing treatment plans that can be used to cure the diseases. The methods can include computerized methods, such as methods aided by a data processing system. The proposed treatment plans can be evidence-based, having evidence such as data from literature including, for example, clinical trials, case studies, research, journal articles, and conference presentations and proceedings, among other data types, and the reasoning for selecting the treatment plans from the evidence.

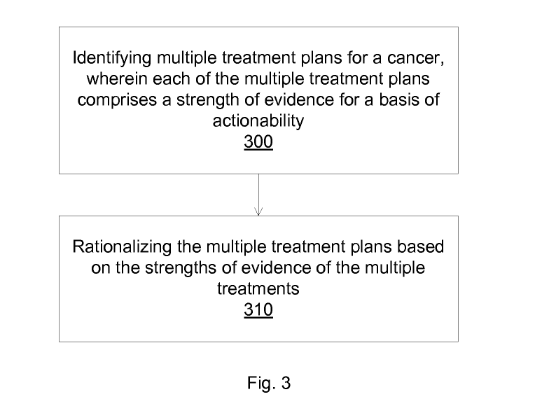

FIG. 3 illustrates an example of a flowchart for a method for formulating treatment plans used in treating a disease such as cancer. Operation 300 identifies multiple treatment plans for a disease, with each treatment plan having a strength of evidence for a basis of actionability. The strength of evidence can include data showing that the treatment plan can be successful. For example, the treatment may have been proven to have shown successful improvement to a patient in a similar case. The basis of actionability can include data showing a direct function important to the treatment of the disease.

For example, in a cancer patient, the strength of evidence can include clinically available drugs that can target a gene product that is differentially expressed in tumor versus normal elements. The strength of evidence can include information about biomarkers used in a course of cancer diagnostic or treatment, such as standards that outline a treatment plan for patients harboring aberrations in a biomarker; information related to where and how a molecular abnormality is considered a therapeutically relevant biomarker; an availability of biomarkers that are clinically validated and have approved drugs that target them; an availability of biomarkers that are clinically validated, and in widely accepted treatment guidelines; an availability of biomarkers having clinical evidence suggesting responsiveness to one or more drugs or classes when the biomarkers are present; an availability of biomarkers being direct targets of approved/investigational drugs; an availability of biomarkers being part of a pathway that can be targeted by approved or investigational drugs; an availability of biomarkers bearing similarity to other biomarkers that are deemed actionable; or an availability of a biomarker selected from biomarkers having at least one of the following factors: (i) clinical evidence suggesting responsiveness to one or more drugs or classes when the biomarkers are present, (ii) the biomarkers are direct targets of approved and/or investigational drugs, (iii) the biomarkers are part of a pathway that can be targeted by approved and/or investigational drugs, and (iv) the biomarkers bear similarity to other biomarkers that are deemed actionable.

Operation 310 ranks the multiple treatment plans based on the strength of the evidence of each of the multiple treatments. The rationales for the ranking of the treatment plans can include classification of the treatment plans, for example, based on the strength of evidence providing the levels of support to the treatment plans.

For example, the treatment plans can be classified by the availability of approved drugs with companion diagnostic(s), by the availability of therapeutic approaches outlined in treatment guidelines, by the availability of clinical evidence indicating responsiveness to a drug class, and/or by the availability of pre-clinical evidence indicating responsiveness to drug class.

In a cancer patient, the treatment plans can be rationalized if one or more drugs approved for cancers with specific aberrations make the corresponding biomarkers actionable, if clinical trials with a biomarker aberration is used as an inclusion criteria, if an increasing number of clinical trials seek to enroll patients whose cancers harbor specific aberrations, and/or if evidence exists for genetic disease with a biomarker aberration.

Clinical decision-making in the therapeutic approach for a patient with a given cancer, characterized by multiple aberrations in one or more genes, may be aided with the use of a biomarker actionability framework in an evidence-based treatment model that provides evidence on whether or not a gene can be considered a therapeutically relevant biomarker, and if so, how the gene should be considered. The evidence-based treatment model can be used for biomarkers in cancer treatment, in which a biomarker may be considered actionable if it has a basis of actionability, such that the oncogenic properties of cells harboring an aberration in the biomarker can be ameliorated by clinically available drugs, and a rationale for actionability provides the strength of evidence for a particular therapeutic approach in targeting cancer cells with aberrations in the biomarker.

In some embodiments, the present invention discloses methods, and data processing systems to perform the methods, to form treatment plans based on a framework of actionability. The methods can be used in treatment plans having actionable biomarkers, such as, for example, those in which the biomarkers are oncogenic and/or differentially expressed on tumor cells, and for which a treatment approach can be crafted that mitigates its oncogenic potential and/or permits the recognition and destruction of tumor cells. Driver aberrations can be targeted by interfering with their function, or by exploiting them to identify and select tumor cells for destruction. The actionable biomarkers can also include passenger biomarkers, the biomarkers that can be used to select cancer cells for destruction by virtue of the targeting agent recognizing differences between cancer and normal elements.

In some embodiments, the present invention discloses a framework for developing guidelines for actionability, as they relate to genomically-based cancer therapeutics. The increasing scope and availability of genetic testing options for patients suffering from cancer has raised questions about how to use results of molecular diagnostics to inform patient care. For some biomarkers (e.g. BRAF mutations in melanoma), standards exist that outline treatments for individuals harboring aberrations in the biomarker. For the vast majority of genomic abnormalities, however, few guidelines exist. Clinical decision-making and the therapeutic approach for a patient with a given cancer characterized by aberrations in different genes may be aided by the use of a biomarker actionability framework that provides levels of evidence regarding whether or not a molecular abnormality can be considered a therapeutically relevant biomarker and the mechanism for how a molecular abnormality can be considered. A gene may be considered theoretically actionable if it has a basis of actionability, such that clinically available drugs can target a gene product that drives the cancer or is differentially expressed in tumor versus normal elements.

Cancer is a serious and pervasive disease, with about 30% of people potentially becoming afflicted with cancer during their lifetime and approximately 50% to 60% of the people that contract cancer eventually succumbing to the disease.

Lung cancer, breast cancer, and ovarian cancer are amongst the most common cancers. In general, a difficulty with cancer treatment can be an inability to predict response to specific therapies. For example, empirical-based treatment strategies can be used, and many patients with chemo-resistant disease can receive multiple cycles of toxic therapy without success before the lack of efficacy is identified.

Early detection and diagnosis of cancer can significantly improve the clinical outcome of patients through the use of suitable tumor markers (e.g, biomarkers). The biomarkers can be important for patients having vague or no symptoms or patients having tumors that are relatively inaccessible to physical examination.

In some embodiments, the present invention discloses solid, evidence-based methodologies which use a specific patient's condition and diagnostic to provide potential treatment options. For example, oncologists must make risk-benefit decisions regarding chemotherapy in the course of cancer treatment, and they sometimes do not have well-founded guidelines, evidence-based rationale, or decision support protocols. Chemotherapy regimen guidelines based on expert panel reviews of the literature can be used, but these guidelines are not refined to optimize decisions for individual patients to arrive at treatment approaches based on the specific risks and responses of the individual patients.

The present actionability framework can provide improvements in clinical care for cancer patients, for example, by providing strategies for oncology practitioners' clinical decisions, based on research evidence regarding risk factors and individual patient data that balances dose and risk considerations. With such information, physicians can determine the possibility of adverse outcomes with recommended standards of care and can modify therapy when needed, and can reduce needless undertreatment and rationalize the use of expensive adjunctive therapies.

The use of evidence-based methodology can offer significant benefit as compared to suggestive-based methodology, such as the application of statistical methods to the treatment of disease. For example, statistical methods can employ logistic regression methods that relate clinical variables from patients with the probable treatment outcomes for those patients. Thus the statistical methods can estimate the probability of the effectiveness of the proposed treatment, without solid evidence that the treatment will produce a favorable outcome. Although a relationship between the clinical variables for a patient and the likely treatment outcome for that patient may be observed, the focus is not on the patient but rather on a set of clinical test results. Thus, the basis of statistical methods can be questioned.

In contrast, the present evidence-based methods rely on real evidence for a beneficial impact, providing reasons and citations to support the proposed treatment plans. The methods can use specific information such as genetic data from the patients. The present methods can be considered to be equivalent to a group of physician experts working on the patients, thus the proposed treatment plans can be as good as those provided by the best physicians in the best facilities with the best and latest technologies.

The choice of a treatment approach for a cancer patient is a common task for cancer specialists and oncologists. In some embodiments, the present methods for ascertaining individualized treatments can include genomic information, age, and previous treatment history as well as the response to these treatments, among other personal information. The methods can integrate the publically available knowledge bases (e.g, ClinicalTrials.gov, and the NCI Thesaurus), along with expert guidance, to create evidence-based decision rules that expand the criteria regarding trials to include molecular target information.

In some embodiments, the methods can divide the biomarkers into three groups. In the first group are a handful of biomarkers that are clinically validated, may be in widely accepted treatment guidelines (such as the NCCN guidelines, or FDA guidelines) and may have approved drugs that target them. These include BRAF V600 mutation for melanoma, EGFR mutation and ALK fusion for lung cancer, HER2 amplification or overexpression for breast cancer, and KRAS mutation for colorectal cancer.

In the second group are biomarkers that have a basis for “actionability” having one or more of the following factors: (i) clinical evidence suggesting responsiveness to one or more drugs or classes when the biomarkers are present, (ii) the biomarkers are direct targets of approved and/or investigational drugs, (iii) the biomarkers are part of a pathway that can be targeted by approved and/or investigational drugs, or (iv) the biomarkers bear similarity to other biomarkers that are deemed actionable.

Finally, the third group includes biomarkers for which there is no discernable link to actionability.

A conceptual framework for basis of actionability is outlined in Table 1. Briefly, the framework divides biomarkers into those that do or do not have a function directly important to tumor pathogenesis. It should be kept in mind, however, that these dichotomies are sometimes blurred. For instance, passenger mutations can at times be indirectly related to, or responsible for development of functional changes and, regardless, can generate therapeutic vulnerabilities in cancer. Further stratification includes those biomarkers that can be targeted directly versus indirectly by approved versus investigational drugs, and finally those that may be homologous to each of the types of biomarkers mentioned above.

TABLE 1
Basis of actionability

| Biomarker Criteria | Definition of Biomarker Criteria | Example |
|---|---|---|
| Functional in driving the | Biomarker is a direct target of one or more | ALK |
| malignancy and can be | approved drugs, and targeting it will interfere | |
| targeted by approved | with malignant cell growth. | |
| drug(s) | | |
| Functional in driving the | Biomarker is a direct target of one or more | AKT1 |
| malignancy and can be | investigational drugs, and targeting it will | |
| targeted by investigational | interfere with malignant cell growth. | |
| drug(s) | | |
| Direct component of an | Biomarker may not be directly targeted by | PTEN |
| actionable pathway that can | approved or investigational drugs, but instead | |
| be targeted by approved | is part of a pathway that drives the malignancy | |
| and/or investigational drugs | and can be directly targeted by drugs. | |
| Indirect component of an | Biomarker itself may not be directly targeted | FBXW7 |
| actionable pathway that can | by approved or investigational drugs, but | |
| be targeted by approved | influences the activity or expression of other | |
| and/or investigational drugs | proteins that can be targeted by either | |
| | approved and/or investigational drugs. | |
| Homologous to an | Biomarker itself may not be a target for | GNAO1 |
| actionable biomarker that | clinically available drugs, but may be | |
| can be either directly or | homologous to biomarkers that are targetable. | |
| indirectly targeted by | | |
| approved and/or | | |
| investigational drugs | | |
| Can be targeted by drug(s) | Biomarker may not be functionally important | CD20, |
| even if the biomarker is not | in the malignancy, yet can be expressed | CD30 |
| itself functional in driving | aberrantly or differentially in cancer cells and, | |
| the malignancy | hence, exploited for targeted delivery. | |

The first biomarker criteria can include biomarkers that can be functional in driving the malignancy and can be targeted by approved drugs. A biomarker may be considered actionable if it is a direct target of one or more approved drugs, and if targeting it will interfere with malignant cell growth. For example, the ALK-inhibitor crizotinib is approved for the treatment of ALK-rearranged, non-small cell lung cancer. It also inhibits MET kinases and ROS 1 kinases, and may be a potential therapeutic option for cancers with driver aberrations in these genes.

The second biomarker criteria can include biomarkers that can be functional in driving the malignancy and can be targeted by investigational drugs. A biomarker may be considered actionable if it is a direct target of one or more investigational drugs, and targeting it will interfere with malignant cell growth. For example, several investigational drugs, such as MK-2206 and GDC-0068, inhibit AKT1 and clinical trials with these agents may be treatment options that warrant consideration for cancers with activating AKT1 aberrations.

The third biomarker criteria can include biomarkers that can be a direct component of an actionable pathway that can be targeted by approved and/or investigational drugs. A biomarker may not be directly targeted by approved or investigational drugs, but instead it may be part of a pathway that drives the malignancy and can be directly targeted by drugs. For example, the tumor suppressor PTEN is not currently the target of a drug or class of drugs. However, reduced PTEN function leads to increased activity of the PI3K/AKT/mToR pathway that is targeted by drugs from several drug classes.

The fourth biomarker criteria can include biomarkers that can be an indirect component of an actionable pathway that can be targeted by approved and/or investigational drugs. A biomarker itself may not be a target for clinically available drugs, but influences the activity or expression of other proteins that can be targeted by either approved and/or investigational drugs. For example, FBXW7 is not a target of clinically available drugs nor is it part of a pathway, but it does regulate the expression of many different proteins because it functions as an ubiquitin ligase that targets proteins for degradation. FBXW7 directly regulates proteins such as mTOR and NOTCH1, both of which are targets of clinically available drugs. Studies have shown that cells deficient for FBWX7 demonstrate increased levels of active mTOR and NOTCH1. Thus, mTOR or NOTCH1 inhibitors could be effective in ameliorating the consequences of FBXW7 inactivation in cancer cells.

The fifth biomarker criteria can include biomarkers that can be homologous to an actionable biomarker that can be either directly or indirectly targeted by approved or investigational drugs. A biomarker itself may not be a target for clinically available drugs, but may be homologous to biomarkers that are targetable. For example, GNAO1 is a member of the G-alpha protein family of GTPases and shares homology with GNAQ and GNA11, biomarkers that predict responsiveness to MEK inhibitors. Knowledge about GNAQ or GNA11 may help inform potential treatment approaches for GNAW-aberrant cancers. The other aspect of this homology is the finding of new mutations. For instance, a new, previously un-described mutation found in BRAF might be considered actionable in a manner similar to known BRAF mutations. A potential solution may be to model the homologous biomarker or the new mutation in silico and/or perform pre-clinical experiments, and determine whether or not this biomarker is predicted to be activating in a manner similar to BRAF V600E (in the case of a novel BRAF mutation) or the homologous biomarker.

The sixth biomarker criteria can include biomarkers for which the presence of the biomarker/aberration can be targeted by drugs, even though the biomarker is not itself functional in driving the malignancy. A biomarker may not be functionally important in the malignancy, yet can be expressed aberrantly or differentially in cancer cells and, hence, can be exploited for targeted delivery. One example is the CD20 antigen, a B-cell-specific differentiation antigen expressed on mature B-cells and in most B-cell non-Hodgkin's lymphomas. Several antibodies targeting CD20 exert their anti-tumor effect by complement-dependent cytotoxicity, antibody-dependent cell-mediated cytotoxicity, and/or through antibody binding to antigen leading to anti-proliferative or apoptotic effects on cells expressing the target antigen. Rituximab is a CD20-directed cytolytic antibody approved for CD20-positive Non-Hodgkin's lymphoma or chronic lymphocytic leukemia. Another example is the CD30 antigen, which is expressed by normal activated lymphocytes and is highly expressed by some malignant cells. Brentuximab vedotin is an antibody-drug conjugate that consists of an antibody targeting the CD30 antigen linked to a chemotherapeutic agent monomethyl auristatin E (MMAE), which inhibits microtubule polymerization. Brentuximab vedotin is approved for Hodgkin's lymphoma and systemic anaplastic large cell lymphoma, both of which express high levels of CD30.

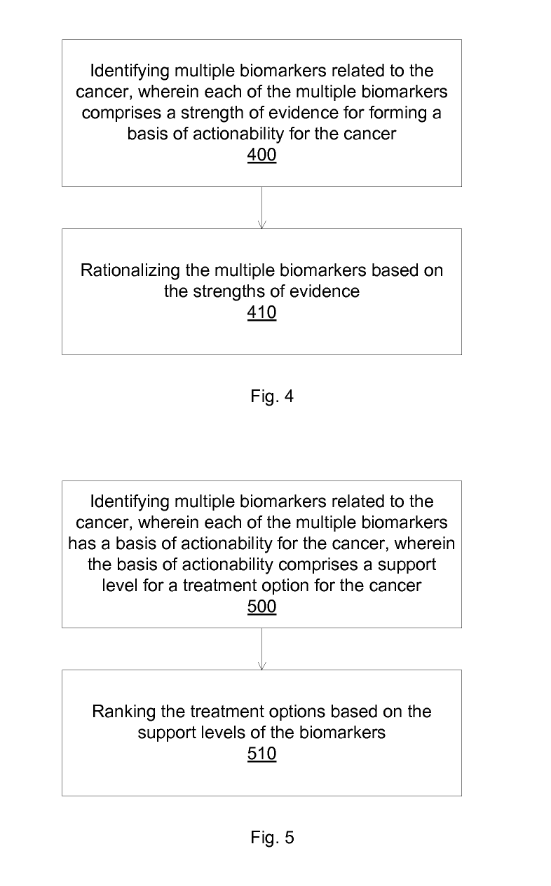

FIG. 4 illustrates a flowchart for a method for formulating treatment plans, for example, used in treating a disease such as cancer. The method can be used for prioritizing treatment options for a cancer patient. Operation 400 identifies multiple biomarkers related to the cancer, for which each of the biomarkers can have a strength of evidence for forming a basis of actionability for the cancer treatment. The strength of evidence can include data showing that the treatment plan can be successful, such as evidence of success in an earlier similar case in which improvements to the patient had been demonstrated. The basis of actionability can also include data showing a direct function important to the treatment of the disease.

For example, the strength of evidence of the biomarker can include that the biomarker is configured for classification and treatment of the cancer.

The strength of evidence of the biomarker can include, for example, the following:
that the biomarker comprises measurable molecular or cellular elements linked to a health outcome or state;
the biomarker is oncogenic or differentially expressed on tumor cells, and a treatment approach can be crafted that mitigates its oncogenic potential and/or permits the recognition and destruction of the tumor cells;
the biomarker is clinically validated and has approved drugs that target it;
the biomarker is clinically validated, and in widely accepted treatment guidelines;
the biomarker has clinical evidence suggesting responsiveness to one or more drugs or classes when the biomarker is present;
the biomarker is direct target of approved/investigational drugs;
the biomarker is part of a pathway that can be targeted by approved or investigational drugs;
the biomarker bears similarity to other biomarkers that are deemed actionable;
the biomarker is selected from biomarkers having at least one of the following factors: (i) clinical evidence suggesting responsiveness to one or more drugs or classes when the biomarker is present, (ii) the biomarker is a direct target of approved and/or investigational drugs, (iii) the biomarker is part of a pathway that can be targeted by approved and/or investigational drugs, and (iv) the biomarker bears similarity to other biomarkers that are deemed actionable;
the biomarker is a direct target of one or more approved drugs, and if targeted, will interfere with malignant cell growth;
the biomarker is functional in driving the malignancy and can be targeted by an approved drug;
the biomarker is a direct component of an actionable pathway that can be targeted by an approved or investigational drug;
the biomarker is part of a pathway that drives the malignancy and can be directly targeted by a drug;
the biomarker is an indirect component of an actionable pathway that can be targeted by an approved or investigational drug;
the biomarker influences the activity or expression of other proteins that can be targeted by either an approved or investigational drug;
the biomarker is homologous to an actionable biomarker that can be either directly or indirectly targeted by an approved or investigational drug;
the presence of the biomarker can be targeted by a drug even if the biomarker is not itself functional in driving the malignancy; and/or
the biomarker expresses aberrantly or differentially in cancer cells and is exploited for targeted delivery.

The strength of evidence of the biomarker can include pre-clinical data indicating that an aberration or class of aberrations in the biomarker responds to a specific drug or drug class, clinical data on the therapeutic response of the biomarker within the context of a non-cancer disease, standard clinical treatment guidelines recommending that cancers with aberrations in the biomarker should or should not be treated with certain drugs and drug classes, and/or clinical data indicating that the biomarker is predictive of a therapeutic response.

The clinical data can come from a drug development process, with different phases providing varying levels of evidence of the effectiveness of the drug. In general, a drug development process can include an exploratory research phase and a research phase, a pre-clinical development phase, a clinical development phase, and a product registration and approval phase.

In the research phases, including the exploratory research phase, the drug is validated and in vivo tested. Animal models can be developed to test the new drug. In the pre-clinical development phase, the new drug's pharmacodynamics, pharmacokinetics, ADME and toxicity are determined using blood and tissues.

In the clinical development phase, testing of the new drug in humans commences, and includes multiple phases such as phase I, phase II, and phase III.

In Phase I, sometimes called, “first in human” trials, trials are conducted to determine how the new drug works in humans, its safety profile, and an assessment of the required dosage range for the drug. For example, human metabolism can differ markedly from animals so that the drug can have a different effect on humans as compared to animals. Phase I trials can determine a general maximum safe or tolerated dose and a general side effect profile.

In phase II, the trials test for efficacy, safety, and side effects in patients with the pure form of the disease for which the new drug is intended. In other words, the new drug is tested on patients having the intended disease, but suffering little other intercurrent disease, and with restricted concomitant medications. Early phase II trials can be pilot trials to determine dose range. Subsequent phase II trials can be used to determine dosage relationships, such as safety and efficacy, of the treating compounds in the new drug.

In phase III, the trials aim at demonstrating the efficacy and safety of the new drug in large numbers of patients, including general populations and special populations with all forms of the disease or conditions to be treated.

After the clinical development, the drug can be ready for product registration and approval.

The clinical data can come from different phases, with phase III trials (or studies) providing the most robust evidence, and phase I and II trials (or studies) or retrospective studies or registry data providing less definitive evidence. The clinical data can include at least one of phase III studies, phase I and II studies, case reports, retrospective studies, registry data, and navigation or umbrella studies that demonstrate that patients with a specific biomarker may respond to certain treatments.

Operation 410 rationalizes the multiple biomarkers based on the strengths of evidence. The rationale can include classification of the treatment plans, for example, based on the strength of evidence for providing the levels of support to the treatment plans.

The rationalizing of the biomarkers, for example, can include an existence of drugs approved with a companion diagnostic, an existence of one or more drugs approved for cancers with specific aberrations which makes the corresponding multiple biomarkers actionable, an existence of a therapeutic approach outlined in treatment guidelines, an existence of clinical trials with an aberration or multiple aberrations in the multiple biomarkers as an inclusion criteria, an existence of an increasing number of clinical trials seeking to enroll patients whose cancers harbor specific aberrations in the multiple biomarkers, an existence of pre-clinical evidence or clinical evidence indicating responsiveness of the multiple biomarkers to a drug class, and/or evidence of genetic disease with aberration in the multiple biomarkers.

Rationalizing the biomarkers can include selecting a biomarker of the multiple biomarkers in which the strength of evidence for the biomarker has a highest strength of evidence for a given cancer.

FIG. 5 illustrates a flowchart for a method for formulating treatment plans, for example, for use in treating a disease such as cancer. The method can be used for prioritizing treatment options for a cancer patient. Operation 500 identifies multiple biomarkers related to the cancer, with each of the biomarkers having a basis of actionability for the cancer, and the basis of actionability having a support level for a treatment option for the cancer. The basis of actionability can include data showing a direct function important to the treatment of the disease.

For example, the support level can include standards that outline a treatment plan for patients harboring aberrations in the biomarker or can include clinically available drugs that can target a gene product that is differentially expressed in tumor versus normal elements. The support level can also include information related to where and how a molecular abnormality of the biomarker is considered a therapeutically relevant biomarker.

The basis of actionability for the biomarker can include that the biomarker is configured for classifications and treatments of the cancer; that the biomarker comprises measurable molecular or cellular elements linked to a health outcome or state; that the biomarker is oncogenic or differentially expressed on tumor cells, and a treatment approach can be crafted that mitigates its oncogenic potential and/or permits the recognition and destruction of the tumor cells; that the biomarker is clinically validated and has approved drugs that target it; that the biomarker is clinically validated, and in widely accepted treatment guidelines; that the biomarker has clinical evidence suggesting responsiveness to one or more drugs or classes when the biomarker is present; that the biomarker is a direct target of approved and/or investigational drugs; that the biomarker is part of a pathway that can be targeted by approved and/or investigational drugs; that the biomarker bears similarity to other biomarkers that are deemed actionable; that the biomarker has at least one of the following factors: (i) clinical evidence suggesting responsiveness to one or more drugs or classes when the biomarker is present, (ii) the biomarker is a direct target of approved and/or investigational drugs, (iii) the biomarker is part of a pathway that can be targeted by approved and/or investigational drugs, or (iv) the biomarker bears similarity to other biomarkers that are deemed actionable; and/or that the biomarker is a direct target of one or more approved drugs, and if targeting it will interfere with malignant cell growth.

The basis of actionability for the biomarker can include that the biomarker is functional in driving the malignancy and can be targeted by an approved drug; that the biomarker is a direct component of an actionable pathway that can be targeted by an approved or investigational drug; that the biomarker is part of a pathway that drives the malignancy and can be directly targeted by a drug; that the biomarker is an indirect component of an actionable pathway that can be targeted by an approved or investigational drug; that the biomarker influences the activity or expression of other proteins that can be targeted by either an approved or investigational drug; that the biomarker is homologous to an actionable biomarker that can be either directly or indirectly targeted by an approved or investigational drug; that the presence of the biomarker can be targeted by a drug even if the biomarker is not itself functional in driving the malignancy; that the biomarker expresses aberrantly or differentially in cancer cells and is exploited for targeted delivery; that standard clinical treatment guidelines recommend that cancers with aberrations in the biomarker should or should not be treated with certain drugs and drug classes; that pre-clinical data is available for the biomarker indicating that an aberration or class of aberrations in the biomarker responds to a specific drug or drug class; that clinical data is available on the therapeutic response of the biomarker within the context of a non-cancer disease, wherein the basis of actionability for the biomarker comprises that available clinical data indicating that the biomarker is predictive of a therapeutic response.

The clinical data can come from different sources, with Phase III studies providing the most robust evidence, and Phase I and Phase II studies or retrospective studies or registry data providing less definitive evidence. The clinical data can include at least one of Phase III studies, Phase I and Phase II studies, case reports, retrospective studies, registry data, and navigation or umbrella studies that demonstrate that patients with a specific biomarker may respond to certain treatments.

Operation 510 ranks the treatment options based on the support levels of the biomarkers. The rationales can include classifying and ranking the treatment plans based on the support levels of the biomarkers.

For example, a treatment option can be ranked higher than other treatment options if approved drugs with companion diagnostic are available for the treatment option. A treatment option can be ranked higher than other treatment options if the treatment option comprises one or more drugs approved for cancers with specific aberrations which makes the corresponding biomarkers actionable. A treatment option can be ranked higher than other treatment options if the treatment option comprises a therapeutic approach outlined in treatment guidelines. A treatment option is ranked higher than other treatment options if the treatment option comprises clinical trials with the biomarker aberration as an inclusion criteria. A treatment option can be ranked higher than other treatment options if the treatment option comprises an increasing number of clinical trials seeking to enroll patients whose cancers harbor specific aberrations. A treatment option can be ranked higher than other treatment options if the treatment option comprises a pre-clinical evidence or clinical evidence indicating responsiveness to drug class. A treatment option can be ranked higher than other treatment options if the treatment option comprises evidence of genetic disease with biomarker aberration.

The framework can also include a rationale for actionability in which strength of evidence for a biomarker is mapped to highest strength of evidence for a given cancer. In the present invention, an actionability framework is provided for use in the development of potential treatment approaches as well as clinical research strategies for diverse malignancies.

Possible rationales for actionability are summarized in Table 2. Briefly, rationales range in ranked order from biomarkers for which an approved treatment drug is available with a companion diagnostic, for which therapeutic approaches in treatment guidelines are available, for which clinical evidence indicating responsiveness is available, for which clinical trials with the biomarker are available, for which pre-clinical evidence for the biomarker is available, and for which evidence in hereditary (genetic) disease regarding the biomarker with possible extrapolation to malignancy is available. Biomarkers for which one or more approved treatment drugs are available with companion diagnostics and/or those for which therapeutic approaches in treatment guidelines are available (as in FDA and NCCN guidelines, for example) have the highest level of support for their actionability.

TABLE 2
Rationales for actionability

| Biomarker Criteria | Definition of Biomarker Criteria | Example |
|---|---|---|
| Drug approved with | A drug is approved for cancers with an | BRAF, |
| companion diagnostic | aberration in that biomarker. | HER2, KIT |
| Therapeutic approach | Standard clinical treatment guidelines | KRAS, |
| outlined in treatment | recommend that cancers with aberrations in | NRAS, EGFR |
| guidelines (e.g. NCCN | that biomarker should (or should not) be | |
| guidelines) | treated with certain drugs and drug classes. | |
| Clinical evidence | Available clinical data suggests that | BRAF, |
| indicating responsiveness | aberrations within the biomarker may be | PIK3CA, |
| to drug class(es) | predictive of therapeutic response. | HER2, TP53 |
| Clinical trials with | Clinical trials seek to enroll patients whose | CDK6 |
| biomarker aberration as | cancers harbor specific aberrations in that | |
| an inclusion criteria | biomarker. | |
| Pre-clinical evidence | Available pre-clinical data suggests that | MAP3K9 |
| indicating responsiveness | aberrations within the biomarker may be | |
| to drug class(es) | predictive of therapeutic response. | |
| Evidence in genetic | Available clinical data on the therapeutic | TSC1 |
| disease with biomarker | response of the biomarker within the context | |
| aberration | of a non-cancer disease. | |
| No evidence | A biomarker is not considered to be | ADAMTS20 |
| | actionable if there is no data on the above | |
| | mentioned criteria for that biomarker. | |

The first rationale, the highest ranking in the framework or classification for biomarker treatment actionability in an embodiment of the present invention, can include the availability of approved drugs with companion diagnostic. Several drugs are now approved for cancers with specific aberrations thus making the corresponding biomarkers actionable. For example, vemurafenib and dabrafenib are approved for the treatment of melanoma with BRAF V600E aberrations; trametinib is approved for melanoma with BRAF V600E or BRAF V600K aberrations. Trastuzumab, pertuzumab, lapatinib, and trastuzumab emtansine are approved for the treatment of breast cancer with HER2 overexpression, and imatinib is approved for the treatment of KIT-positive gastrointestinal stromal tumors (GISTs).

The second rationale, with the second highest ranking in the framework or classification for biomarker treatment actionability in an embodiment of the present invention, can include a therapeutic approach outlined in treatment guidelines such as FDA or NCCN guidelines. A biomarker may be considered actionable if standard clinical treatment guidelines recommend that cancers with aberrations in that biomarker should (or should not) be treated with certain drugs and drug classes. For example, standard treatment guidelines recommend KRAS and NRAS testing for colorectal cancer patients and that patients with KRAS- and NRAS-mutated colorectal cancer not be treated with epidermal growth factor receptor inhibitors such as cetuximab and panitumumab.

Another example is EGFR, where standard treatment guidelines recommend testing for EGFR mutations in patients with non-small cell lung cancer. Patients whose tumors harbor sensitizing EGFR mutations should receive the EGFR tyrosine kinase inhibitors erlotinib, gefitinib, or afatinib as first-line therapy.

The third rationale, with the third highest ranking in the framework or classification for biomarker treatment actionability in an embodiment of the present invention, can include clinical evidence indicating responsiveness to drug classes. A biomarker may be considered actionable if available clinical data suggests that the biomarker is predictive of therapeutic response. Clinical data may come from different sources, with Phase III studies providing the most robust evidence, and Phase I or Phase II studies, retrospective studies, or registry data providing less definitive evidence. Importantly, genomics has unveiled substantial complexity and heterogeneity associated with cancers. As such, more “rare” tumor subtypes are being recognized and it is increasingly evident that the ability to perform randomized trials to ascertain efficacy for these patients is a monumental hurdle. This has been acknowledged by regulatory agencies as well. For instance, the FDA approved the multikinase inhibitor imatinib in ultra-rare disorders such as aggressive systemic mastocytosis, dermatofibrosarcoma protuberans, PDGFR-rearranged myeloprofierative disease, and others based on high response rates in small numbers of patients bearing the cognate biomarker that participated in Phase II studies or were described in case reports. Balancing the need for validated efficacy data versus the reality that cancers may be increasingly stratified by their biomarkers into rare subsets is therefore a defining issue for cancer therapeutics. Examples of the type of clinical evidence that might be collected follows:

a. Phase III studies. For instance, in a Phase III clinical trial, melanoma patients with BRAF V600E-mutated melanoma had higher clinical response rates to treatment with the BRAF inhibitor, vemurafenib, than the chemotherapy, dacarbazine.

b. Phase I or Phase II studies. For example, in Phase I clinical trials, patients with PIK3CA-aberrant cancer had a higher clinical response rate to treatment with PI3K/AKT/mTOR inhibitors than patients who lacked these aberrations.

c. Case reports. For example, a non-small cell lung cancer patient whose tumor harbored a HER2 exon 20 mutation showed tumor shrinkage on a treatment regimen that included anti-HER2 drugs. Another example is a patient diagnosed with spindle cell neoplasm harboring a KIAA1549-BRAF fusion protein and PTEN deletion that responded to a RAF and mTOR kinase targeted combination inhibitor therapy.

d. Retrospective studies. For example, a retrospective study reported that patients with advanced cancers harboring TP53 aberrations experienced longer progression-free survival on treatment regimens containing bevacizumab.

e. Registry data. For example, genomic data has been compiled through The Cancer Genome Atlas (TCGA). This database provides a comprehensive overview of the genomic aberrations in a wide variety of cancers. Similarly, registry of clinical observations could be collated. For instance, a breast cancer registry pilot program funded by Susan G. Komen for the Cure was compiled from September 2009 to December 2010, based on twenty diverse oncology practices. A major goal was to generate an anonymized breast cancer registry database to inform future quality of care and research initiatives. The American Society of Clinical Oncology (ASCO) has also envisioned creating observational registries to inform patient care, including data on panomics and precision medicine-based therapies and outcomes.

f. Navigation or umbrella studies (which may be histology-agnostic), that demonstrate that patients with a specific biomarker may respond to certain treatments.

The fourth rationale, with the fourth highest ranking in the framework or classification for biomarker treatment actionability in an embodiment of the present invention, can include clinical trials with biomarker aberration as an inclusion criteria. An increasing number of clinical trials seek to enroll patients whose cancers harbor specific aberrations. For example, the trial NCT01164995 (Study With Wee-1 inhibitor MK-1775 and Carboplatin to Treat p53 Mutated Refractory and Resistant Ovarian Cancer) is seeking ovarian cancer patients whose tumors harbor mutations in TP53. The rationale for this study is that pre-clinical data suggests that abrogation of the G2 checkpoint by inhibition of Wee-1 kinase results in sensitization of p53-deficient tumor cells to DNA-damaging agents [63]. TP53 may be considered actionable because patients with TP53-aberrant ovarian cancer could enroll in such clinical trials. Other trials seeking to match aberrations in specific biomarkers with therapies that either directly target the biomarker, or indirectly with drugs that target downstream effects of the aberrant biomarker include the National Cancer Institute's NCI-MPACT (NCT01827384) and LUNG-MAP (NCT02154490) trials. NCI-MPACT seeks to enroll solid tumor patients with mutations or amplifications in specific pathways, with PARP inhibitor ABT-888 or MK-1175 plus carboplatin given to patients with tumors harboring defects in the DNA repair pathway, the mTOR inhibitor everolimus given to patients with tumors having alterations in the PI3K pathway, and MEK inhibitor trametinib given to patients with tumors that have alterations in the RAS/RAF/MEK pathway. The LUNG-MAP trial is specifically for squamous cell lung cancer patients, and is testing four different targeted therapies and an anti-PD-Ll therapy for patients whose tumors harbor alterations in a number of different biomarkers including PIK3CA, CDK4, CDK6, CCND1, CCND2, CCND3, FGFR1, FGFR2, FGFR3, and HGF/c-MET.

The fifth rationale, with the fifth highest ranking in the framework or classification for biomarker treatment actionability in an embodiment of the present invention, can include pre-clinical evidence indicating responsiveness to drug classes. A biomarker may be considered actionable based on pre-clinical data indicating that an aberration or class of aberrations (e.g., activating or inactivating) in the biomarker responds to a specific drug or drug class. For example, viability of lung cancer cells with an activating MAP3K9 aberration was inhibited by treatment with a MEK inhibitor.

The sixth rationale, with the sixth highest ranking in the framework or classification for biomarker treatment actionability in an embodiment of the present invention, can include evidence in genetic disease with biomarker aberration. A biomarker may also be considered actionable if there is clinical data on the therapeutic response of the biomarker within the context of a non-cancer disease. For example, inactivating mutations in the gene TSC1 result in upregulation of mTOR and cause the disease Tuberous Sclerosis Complex. The drug everolimus, an mTOR inhibitor, is approved for the treatment of tuberous sclerosis. Inactivating mutations in TSC1 are also common in cancer and based on the clinical evidence in a related genetic disease, mTOR inhibitors might also be considered as a treatment option.

Gaps can exist in the evidence-based treatment model due to lack of information regarding treatment plans for certain patients, diseases, or symptoms. Cases might not have any available information, for example, for some rare diseases or for some uncommon patient symptoms and conditions. Other cases might have common features, but may not be identical to known cases. In yet other cases, treatment plans can be suggested based on similarities or educated guesses from available cases, but for which no specific evidence or studies are known to support such a plan.

Interpretation and use of molecular data in clinical decision-making often involves extrapolating predictive data from the tumor site of origin with the highest strength of evidence to a different histology under consideration by the physician. This may be complicated by several issues described below.

Conflicting data in several cancers:

BRAF V600E mutations are predictive of response to BRAF inhibitors in melanoma and have been reported to predict response in other BRAF-positive malignancies such as hairy cell leukemia, histiocytosis, and thyroid cancer, but not in colorectal cancer. The lack of response in colorectal cancer might be due, for example, to the presence of additional anomalies that co-occur with BRAF mutations, or because BRAF inhibition causes feedback activation of EGFR, or because BRAF mutations are not driver abnormalities in colorectal cancer. Given these data, patients with another cancer harboring BRAF mutations may be treated with BRAF inhibitors, or another option. Other considerations might be necessary to make an informed decision.

One consideration is increasing evidence that molecular aberrations often do not segregate by histology; for instance, BRAF mutations can be found in a subset of patients with almost any cancer. Indeed, it may be near impossible to perform definitive clinical trials of BRAF inhibitors in each histology that harbors BRAF mutations. Historically, when approving or accepting a drug for therapeutic application in a specific tumor type as defined by histology, the drug is not expected to be effective for all patients with that tumor type; indeed 80% or more of patients may not respond/benefit. Therefore, if “tumor type” is defined by the presence of a biomarker, rather than by organ of origin, for example, the same principles may apply. An important consideration in the assessment of treatment options might be whether or not patients who have a particular tumor type (e.g. BRAF-mutated cancer) benefit from the therapy overall, rather than if salutary effects for each histologic subtype or patient are present. As with the use of drugs when tumor type is classified histologically, an important consideration for therapy in tumor types classified on the basis of a biomarker might be a comparison of potential efficacy to other treatment options available to the patient.

Aberrations of unknown significance:

The significance or relevance of alternative aberrations in a validated biomarker like BRAF, for which the impact is not known, may require additional consideration. For example, if a new, previously un-described mutation is found in BRAF, it may or may not be considered actionable in a manner similar to BRAF V600E mutations. One solution may be to model the aberration in silico to determine if it is predicted to be activating in a manner similar to BRAF V600E or characterize the functional effects of the aberration using in-vitro or in-vivo experiments. Validation of such approaches is needed.

Tumors are a complex collection of genetic alterations:

A recent study examined the distributions of mutation frequencies, types, and contexts across many different cancer histologies using a panel of 127 significantly mutated genes from well known (e.g, receptor tyrosine kinase signaling pathways) or emerging (e.g, histone modification) cellular processes in cancer. The study reported that most tumors have anywhere from 2 to 6 aberrations in the studied genes. The complexity is further amplified when testing for non-mutation based aberrations in a patient's tumor. For example, in a recent single patient case study of metastatic malignant phyllodes tumor, a comprehensive molecular analysis was performed by using multiple Clinical Laboratory Improvement Amendments (CLIA)-certified labs on the same tumor sample including next-generation sequencing, whole-genome array-based comparative genomic hybridization, proteomics, and immunohistochemistry, which revealed mutations (missense and nonsense), gene amplifications, gene deletions, and aberrant expression patterns in 13 different genes. A potential solution for an oncologist needing to formulate a treatment approach, or a clinical researcher to design a research strategy, that comprehensively addresses all of the aberrations detected in a patient's tumor is a systems biology approach. In this approach, the phenotypic convergence of a collection of aberrations in a tumor at the molecular level is examined and from which, a treatment approach or research strategy is determined based on the identification of oncogenic hubs.

In many instances, including cases in which patients who are exceptional responders to a therapy, a genomic basis of drug sensitivity may not be identified, and in such cases, proteomic or transcriptomic approaches may be helpful in identifying pathways of resistance and/or response.

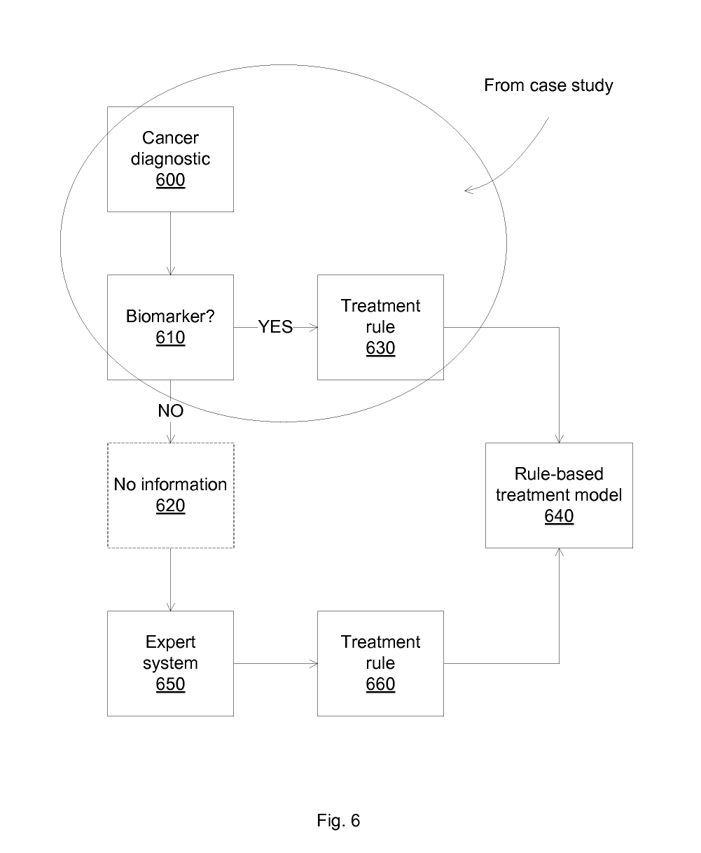

FIG. 6 illustrates an example of a missing logic for a rule based treatment model according to some embodiments. A cancer diagnostic 600 can be provided, in which a biomarker 610 can generate a positive result, resulting in a treatment rule 630. This information can be obtained from a case study. The treatment rule can be used on a rule-based or evidence-based treatment model 640.

In some cases, the same cancer diagnostic 600 can have complications, such as a mutation to the biomarker 610 for which No information 620 is available in the literature addressing this variation.

In some embodiments, the present invention discloses an expert system 650 for addressing missing data in the evidence-based treatment model. The expert system can propose a treatment rule 660 to complement the case study, which can be used in the treatment model 640.

In some embodiments, the methods can create hypothetical case studies or virtual patients to address the gaps in the published knowledge of treatment. The hypothetical case studies or virtual patients can be created based on an inability of the evidence-based treatment model to propose a treatment plan, for example, due to lack of publicly available evidence. For example, hypothetical case studies or virtual patients can be created to fill in a gap, or multiple gaps, in the evidence-based treatment model, for example, to generate a rule for the evidence-based treatment model when encountering a patient with no existing evidence to suggest a treatment plan.

The hypothetical case studies or virtual patients can be created in the course of examining the evidence-based treatment model, for example, during the simulation of the evidence-based treatment model to address the validity of the model. The hypothetical case studies or virtual patients can be created, for example, by examining the available literature, making a new hypothetical case study based on an inference or linkage with an existing case study, or making a virtual patient having minor variations in symptoms or conditions in comparison to patients in a clinical trial.

In some embodiments, the methods can also allow for the generation of new rules, or treatment pathways, based on panels of experts discussing hypothetical case studies on virtual patients. The hypothetical case studies can be proposed based on the lack of available treatment pathways, and can be used to supplement the existing treatment pathways. The panels of experts can include knowledgeable persons, such as researchers and doctors, who can be qualified to discuss treatment plans for patients with particular diseases. For example, virtual patients with new symptoms or with symptoms that do not completely match the criteria of clinical trials, can be suggested to a panel of experts to evaluate possible treatment schemes.

In some embodiments, methods and systems are provided for forming hypothetical case studies and/or virtual patients, which can be used as rules, or can be used in the development of rules, in a rule-based treatment model. The hypothetical case studies or virtual patients can be proposed to improve the efficiency of the treatment model, such as adding rules to the model to address cases that are not covered by real case studies, patients, or clinical trials.

In some embodiments, the virtual patient is a real patient, but not the patient undergoing treatment by the expert system. In this example, a panel of expert physicians discusses the patient, and classifies the case as a hypothetical case involving virtual patients.

The hypothetical case studies or virtual patients can be discussed and treated by an expert system, which can include physicians with outstanding experience and knowledge, who can communicate through peer blog, on-line forum, email, phone calls, and/or other form of communication media. Through the expert systems, the hypothetical case studies and virtual patients can have the same validity as other published literature, leading to a comprehensive evidence-based treatment model.

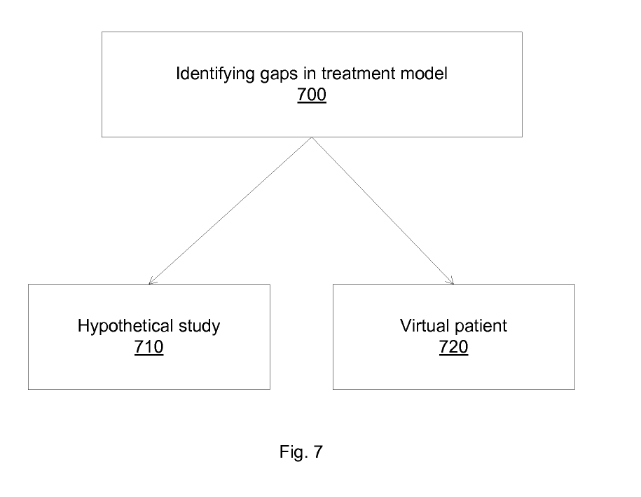

FIG. 7 illustrates an example of a generation of hypothetical study or a virtual patient according to some embodiments. After gaps are identified in the treatment model 700, a hypothetical case study 710 involving a virtual patient 720 can be formed to find a solution for the missing gaps, for example, by an expert system.

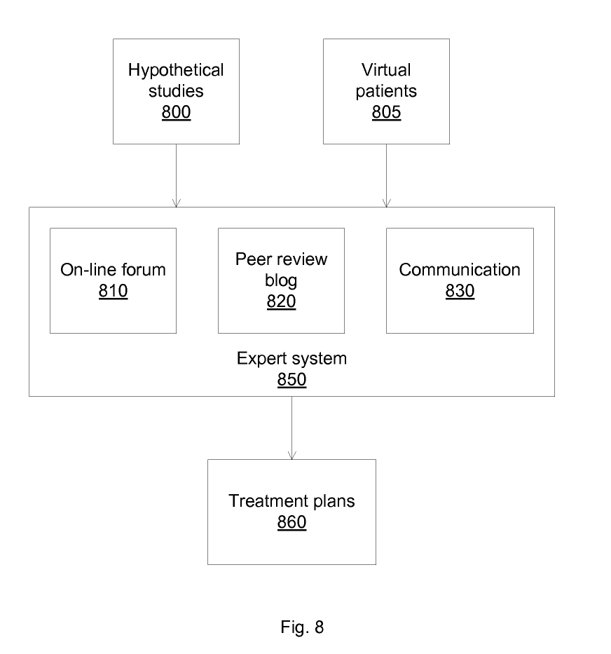

FIG. 8 illustrates an example of a hypothetical study and a virtual patient according to some embodiments. Data from a hypothetical case study 800 involving a virtual patient 805 can be provided to an expert system 850, which can include an online forum 810, a peer review blog 820, and a communication 830 for discussion between physician experts. A treatment plan 860 can be generated, which can be used to form treatment rules for the treatment model.

In some embodiments, methods and systems are provided for forming an expert system, for example, to assist in generating rules for the evidence-based treatment model. The expert systems can include experts in the field of medicine, and thus can provide advice and recommendations of potential treatment plans and directions, for example, with authority. The available treatment information, such as data from literature and clinical trials, can be assembled to provide treatment pathways in the treatment models. Missing treatment pathways, including treatment plans for unknown scenarios such as patients with particular genomes or patients not responsive to available treatments, can be generated by the expert systems.

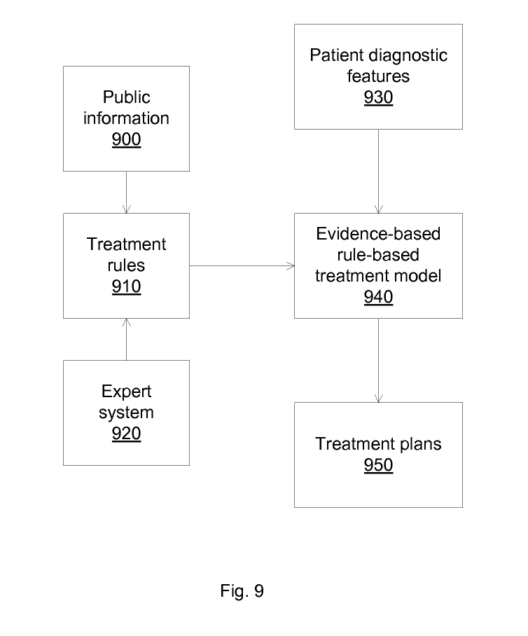

FIG. 9 illustrates an example of a treatment model according to some embodiments. Public information 900, such as data from clinical trials, or research literature, can be combined with information from an expert system 920, to generate treatment rules 910. The treatment rules 910 can be used in an evidence-based and rule-based treatment model 940. For example, patient diagnostic data 930 can be input to a treatment model 940, to generate treatment plans 950. The generated treatment plans can include reasons and evidence for such, as citations from research and clinical trial data.

In some embodiments, the expert systems can include peer review blogs, on-line forum, email, and phone communication. After a hypothetical case study or a virtual patient is identified, discussion between members of the expert systems can commence, potentially resulting in one or more possible treatment plans. The correlation between the problems and the solutions can be converted to rules, which can be implemented in the treatment model.

In some embodiments, the methods can include rules for determining treatment plans based on information on virtual patients and hypothetical case studies, as well as based on publicly-available information on real patients and case studies. Since the treatments of hypothetical case studies and virtual patients are handled by panels of experts, the validity of the treatments can be assured in that the treatments can be endorsed and documented by medical experts with authority and experience. In contrast to artificial intelligence models, the evidence-based methods employing rules generated by real patients, case studies, and clinical trials and rules generated by virtual patients and hypothetical case studies, both the results of medical experts, can have similar validity.

In some embodiments, methods and systems are provided for forming a treatment model and a treatment model which can include rule-based algorithms for proposing treatment plans. The rules are based on evidence, which can include data from published literature, such as clinical trials, case studies and medical references. The evidence can also include data from hypothetical case studies and virtual patients, with proposed treatment plans from expert systems.

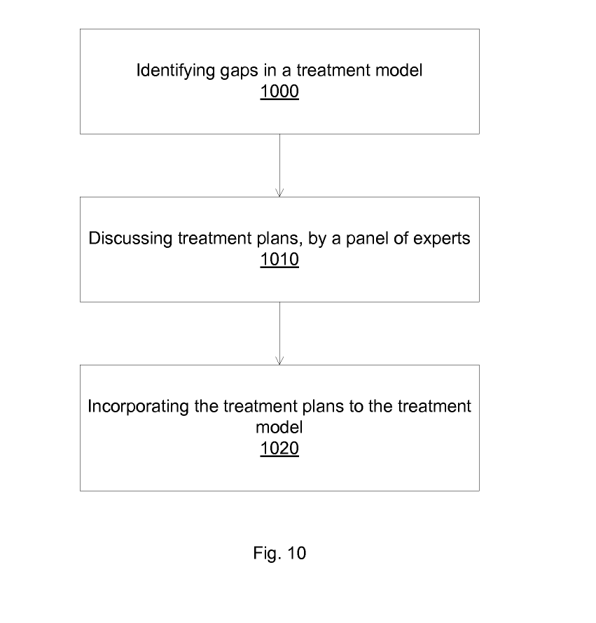

FIG. 10 illustrates an example of a flow chart for generating a treatment model according to some embodiments. Operation 1000 identifies gaps in a treatment model. Operation 1100 discusses treatment plans, by a panel of experts. Operation 1020 incorporates the treatment plans to the treatment model.

In some embodiments, gaps in the treatment model can be identified, and can be converted to hypothetical case studies or virtual patients. The hypothetical case studies or virtual patients then can be treated by panels of experts. The results can be converted to rules for use in the treatment model. The rules generated by the expert systems can complement the rules generated by published literature, allowing a treatment model with wider treatment coverage.

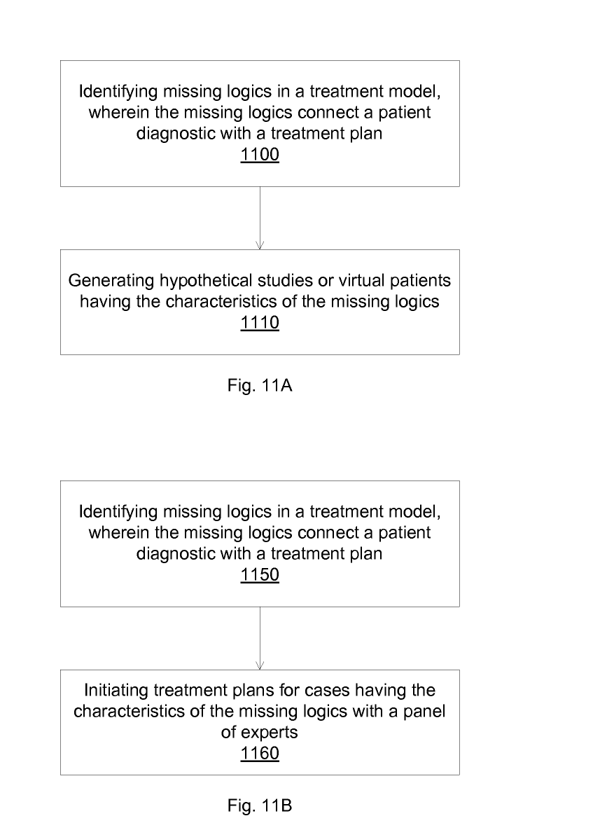

FIGS. 11A and 11B illustrate examples of a flow chart for generating hypothetical studies, virtual patients, or expert systems according to some embodiments. In FIG. 11A, operation 1100 identifies missing logic in a treatment model, wherein the missing logic connects a patient diagnostic with a treatment plan. Operation 1110 generates hypothetical studies or virtual patients having the characteristics of the missing logic.

In FIG. 11B, operation 1150 identifies missing logic in a treatment model, wherein the missing logic connects a patient diagnostic with a treatment plan. Operation 1110 initiates treatment plans for cases having the characteristics of the missing logic with a panel of experts.

In some embodiments, the actionability can include results from a hypothetical study or from a virtual patient. Since the treatment plans formulated in a hypothetical study or for a virtual patient are generated by physician experts, these plans can have the similar validity as from a clinical trial or study.

In some embodiments, provided is a machine-readable storage, having stored there on a computer program having a plurality of code sections for causing a machine to perform the various steps and/or implement the components and/or structures disclosed herein. In some embodiments, the present invention may also be embodied in a machine or computer readable format in, for example, an appropriately programmed computer, and in a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, a nonvolatile electronic memory, or the like. The software program may be run on a variety of devices, such as, for example, a processor.

In some embodiments, the methods can be realized in hardware, software, or a combination of hardware and software. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

The terms “computer program”, “software”, “application”, variants and/or combinations thereof, in the context of the present specification, mean any expression, in any language, code or notation, of a set of instructions intended to cause a system having an information processing capability to perform a particular function either directly, or indirectly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen can be substituted for the mouse. This general purpose computer may be one of the many types well known in the art, such as a mainframe computer, a minicomputer, a workstation, or a personal computer.

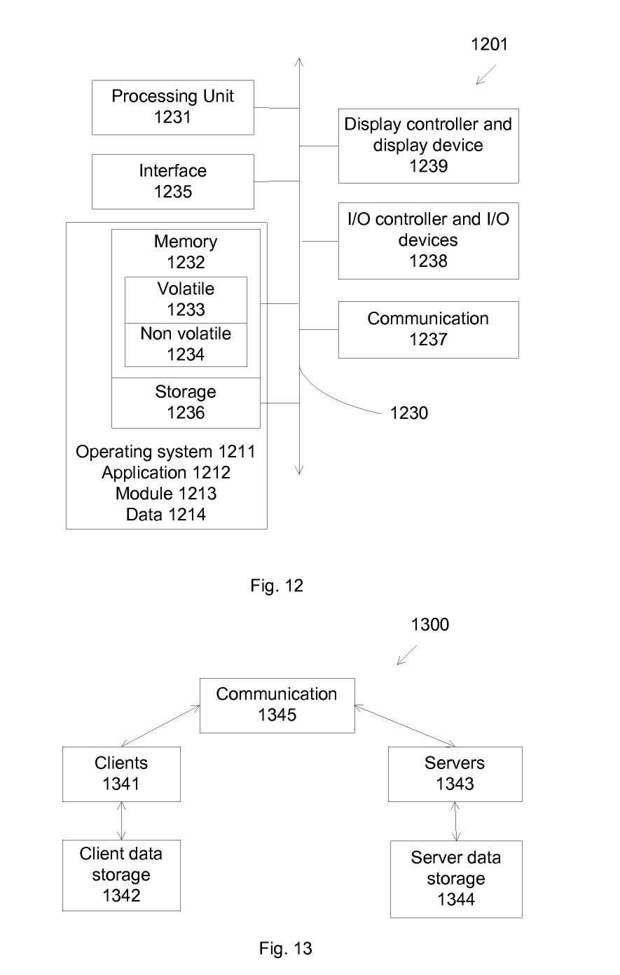

FIG. 12 illustrates a computing environment according to some embodiments. An exemplary environment for implementing various aspects of the invention includes a computer 1201, comprising a processing unit 1231, a system memory 1232, and a system bus 1230. The processing unit 1231 can be any of various available processors, such as single microprocessor, dual microprocessors, or other multiprocessor architectures. The system bus 1230 can be any type of bus structures or architectures, such as 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCST).

The system memory 1232 can include volatile memory 1233 and nonvolatile memory 1234. Nonvolatile memory 1234 can include read only memory (ROM), programmable ROM (PROM), electrically programmable ROM (EPROM), electrically erasable ROM (EEPROM), or flash memory. Volatile memory 1233, can include random access memory (RAM), synchronous RAM (SRAM), dynamic RAM (DRAM), synchronous DRAM (SDRAM), double data rate SDRAM (DDR SDRAM), enhanced SDRAM (ESDRAIVI), Synchlink DRAM (SLDRAM), or direct Rambus RAM (DRRAM).

Computer 1201 also includes storage media 1236, such as removable/nonremovable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1235 can be used to facilitate connection.

The computer system 1201 further can include software, such as an operating system 1211, system applications 1212, program modules 1213, and program data 1214, which are stored either in system memory 1232 or on disk storage 1236. Various operating systems or combinations of operating systems can be used.

Input devices can be used to enter commands or data, and can include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1238. Interface ports 1238 can include a serial port, a parallel port, a game port, a universal serial bus (USB), and a 1394 bus. The interface ports 1238 can also accommodate output devices. For example, a USB port may be used to provide input to computer 1201 and to output information from computer 1201 to an output device. Output adapter 1239, such as video or sound cards, is provided to connect to some output devices such as monitors, speakers, and printers.

Computer 1201 can operate in a networked environment with remote computers. The remote computers, having a memory storage device, can be a personal computer, a server, a router, a network PC, a workstation, a microprocessor based appliance, a peer device or other common network node and the like, and typically includes many or all of the elements described relative to computer 1201. Remote computers can be connected to computer 1201 through a network interface and communication connection 1237, with wire or wireless connections. Network interface can be communication networks such as local-area networks (LAN), wide area networks (WAN) or wireless connection networks. LAN technologies include Fiber Distributed Data Interface (FDDI), Copper Distributed Data Interface (CDDI), Ethernet/IEEE 1202.3, Token Ring/IEEE 1202.5 and the like. WAN technologies include, but are not limited to, point-to-point links, circuit switching networks like Integrated Services Digital Networks (ISDN) and variations thereon, packet switching networks, and Digital Subscriber Lines (DSL).

FIG. 13 is a schematic block diagram of a sample computing environment 1300 with which the present invention can interact. The system includes a plurality of client systems 1341. The system also includes a plurality of servers 1343. The servers 1343 can be used to employ the present invention. The system includes a communication network 1345 to facilitate communications between the clients 1341 and the servers 1343. Client data storage 1342, connected to client system 1341, can store information locally. Similarly, the server 1343 can include server data storages 1344.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

The following reports are hereby incorporated by reference in their entirety.
1. Hoogstraat M, de Pagter M S, Cirkel G A, et al: Genomic and transcriptomic plasticity in treatment-naive ovarian cancer. Genome Res gr.161026.113, 2013
2. Jamal S M, Yu J-H, Chong J X, et al: Practices and Policies of Clinical Exome Sequencing Providers: Analysis and Implications. Am J Med Genet A 161:935-950, 2013
3. Kittaneh M, Montero A J, Gluck S: Molecular Profiling for Breast Cancer: A Comprehensive Review. Biomark Cancer 5:61-70, 2013
4. NCCN Guidelines [Internet] [cited 2014 Jan 2] Available from: http://www.nccn.org/professionals/5.
5. FDA Guidelines [Internet] [cited 2014 Jan 2] Available from: http://www.fda.gov/RegulatoryInformation/Guidances/default.htm
6. Chapman P B, Hauschild A, Robert C, et al: Improved survival with vemurafenib in melanoma with BRAF V600E mutation. N Engl J Med 364:2507-2516, 2011
7. Tsao M-S, Sakurada A, Cutz J-C, et al: Erlotinib in lung cancer—molecular and clinical predictors of outcome. N Engl J Med 353:133-144, 2005
8. Kwak E L, Bang Y-J, Camidge D R, et al: Anaplastic lymphoma kinase inhibition in non-small-cell lung cancer. N Engl J Med 363:1693-1703, 2010
9. Slamon D J, Leyland-Jones B, Shak S, et al: Use of chemotherapy plus a monoclonal antibody against HER2 for metastatic breast cancer that overexpresses HER2. N Engl J Med 344:783-792, 2001
10. Van Cutsem E, Köhne C-H, Hitre E, et al: Cetuximab and chemotherapy as initial treatment for metastatic colorectal cancer. N Engl J Med 360:1408-1417, 2009
11. Muller F L, Colla S, Aquilanti E, et al: Passenger deletions generate therapeutic vulnerabilities in cancer. Nature 488:337-342, 2012
12. McDermott U, Iafrate A J, Gray N S, et al: Genomic alterations of anaplastic lymphoma kinase may sensitize tumors to anaplastic lymphoma kinase inhibitors. Cancer Res 68:3389-3395, 2008
13. Christensen J G, Zou H Y, Arango M E, et al: Cytoreductive antitumor activity of PF-2341066, a novel inhibitor of anaplastic lymphoma kinase and c-Met, in experimental models of anaplastic large-cell lymphoma. Mol Cancer Ther 6:3314-3322, 2007
14. Goozner M: Drug approvals 2011: focus on companion diagnostics. J Natl Cancer Inst 104:84-86, 2012
15. Zou H Y, Li Q, Lee J H, et al: An orally available small-molecule inhibitor of c-Met, PF-2341066, exhibits cytoreductive antitumor efficacy through antiproliferative and antiangiogenic mechanisms. Cancer Res 67:4408-4417, 2007
16. Bergethon K, Shaw A T, Ou S-H I, et al: ROS1 rearrangements define a unique molecular class of lung cancers. J Clin Oncol 30:863-870, 2012
17. Hirai H, Sootome H, Nakatsuru Y, et al: M K-2206, an allosteric Akt inhibitor, enhances antitumor efficacy by standard chemotherapeutic agents or molecular targeted drugs in vitro and in vivo. Mol Cancer Ther 9:1956-1967, 2010
18. Blake J F, Xu R, Bencsik J R, et al: Discovery and preclinical pharmacology of a selective ATP-competitive Akt inhibitor (GDC-0068) for the treatment of human tumors. J Med Chem 55:8110-8127, 2012
19. Pal S K, Reckamp K, Yu H, et al: Akt inhibitors in clinical development for the treatment of cancer. Expert Opin Investig Drugs 19:1355-1366, 2010
20. Choi Y, Zhang J, Murga C, et al: PTEN, but not SHIP and SHIP2, suppresses the PI3K/Akt pathway and induces growth inhibition and apoptosis of myeloma cells. Oncogene 21:5289-5300, 2002
21. Haas-Kogan D, Shalev N, Wong M, et al: Protein kinase B (PKB/Akt) activity is elevated in glioblastoma cells due to mutation of the tumor suppressor PTEN/MMAC. Curr Biol 8:1195-1198, 1998
22. Wu X, Senechal K, Neshat M S, et al: The PTEN/MMAC1 tumor suppressor phosphatase functions as a negative regulator of the phosphoinositide 3-kinase/Akt pathway. Proc Natl Acad Sci USA 95:15587-15591, 1998
23. Akinleye A, Avvaru P, Furqan M, et al: Phosphatidylinositol 3-kinase (PI3K) inhibitors as cancer therapeutics. J Hematol Oncol 6:88, 2013
24. Cheng H, Walls M, Baxi S M, et al: Targeting the mTOR pathway in tumor malignancy. Curr Cancer Drug Targets 13:267-277, 2013
25. Mao J-H, Kim I-J, Wu D, et al: FBXW7 targets mTOR for degradation and cooperates with PTEN in tumor suppression. Science 321:1499-1502, 2008
26. Larson Gedman A, Chen Q, Kugel Desmoulin S, et al: The impact of NOTCH1, FBW7 and PTEN mutations on prognosis and downstream signaling in pediatric T-cell acute lymphoblastic leukemia: a report from the Children's Oncology Group. Leukemia 23:1417-1425, 2009
27. Gupta-Rossi N, Le Bail O, Gonen H, et al: Functional interaction between SEL-10, an F-box protein, and the nuclear form of activated Notchl receptor. J Biol Chem 276:34371-34378, 2001
28. Euw von E, Atefi M, Attar N, et al: Antitumor effects of the investigational selective MEK inhibitor TAK733 against cutaneous and uveal melanoma cell lines. Mol Cancer 11:22, 2012
29. Weekes C D, Hoff Von D D, Adjei A A, et al: Multicenter phase I trial of the mitogen-activated protein kinase 1/2 inhibitor BAY 86-9766 in patients with advanced cancer. Clin Cancer Res 19:1232-1243, 2013
30. Maloney D G: Anti-CD20 antibody therapy for B-cell lymphomas. N Engl J Med 366:2008-2016, 2012
31. Leget G A, Czuczman M S: Use of rituximab, the new FDA-approved antibody. Curr Opin Oncol 10:548-551, 1998
32. Casak S J, Lemery S J, Shen Y L, et al: U.S. Food and drug administration approval: rituximab in combination with fludarabine and cyclophosphamide for the treatment of patients with chronic lymphocytic leukemia. Oncologist 16:97-104, 2011
33. Schirrmann T, Steinwand M, Wezler X, et al: CD30 as a Therapeutic Target for Lymphoma. BioDrugs 1-29, 2013
34. Newland A M, Li J X, Wasco L E, et al: Brentuximab vedotin: a CD30-directed antibody-cytotoxic drug conjugate. Pharmacotherapy 33:93-104, 2013
35. Ballantyne A D, Garnock-Jones K P: Dabrafenib: first global approval. Drugs 73:1367-1376, 2013
36. Wright C J M, McCormack P L: Trametinib: first global approval. Drugs 73:1245-1254, 2013
37. Jelovac D, Emens L A: HER2-directed therapy for metastatic breast cancer. Oncology (Williston Park, N.Y.) 27:166-175, 2013
38. Cohen M H, Farrell A, Justice R, et al: Approval summary: imatinib mesylate in the treatment of metastatic and/or unresectable malignant gastrointestinal stromal tumors. Oncologist 14:174-180, 2009
39. Amado R G, Wolf M, Peeters M, et al: Wild-type KRAS is required for panitumumab efficacy in patients with metastatic colorectal cancer. J Clin Oncol 26:1626-1634, 2008
40. Lièvre A, Bachet J-B, Boige V, et al: KRAS mutations as an independent prognostic factor in patients with advanced colorectal cancer treated with cetuximab. J Clin Oncol 26:374-379, 2008
41. Gleevec FDA Label. FDA
42. Janku F, Tsimberidou A M, Garrido-Laguna I: PIK3CA mutations in patients with advanced cancers treated with PI3K/AKT/mTOR axis inhibitors. Mol Cancer, 2011
43. Janku F, Wheler J J, Westin S N: PI3K/AKT/mTOR inhibitors in patients with breast and gynecologic malignancies harboring PIK3CA mutations. Journal of Clinical . . . , 2012
44. Falchook G S, Janku F, Tsao A S, et al: Non-small-cell lung cancer with HER2 exon 20 mutation: regression with dual HER2 inhibition and anti-VEGF combination treatment. J Thorac Oncol 8:e19-20, 2013
45. Cappuzzo F, Bemis L: HER2 mutation and response to trastuzumab therapy in non-small-cell lung cancer. New England Journal of . . . , 2006
46. Subbiah V, Westin S N, Wang K, et al: Targeted therapy by combined inhibition of the RAF and mTOR kinases in malignant spindle cell neoplasm harboring the KIAA1549-BRAF fusion protein. J Hematol Oncol 7:8, 2014
47. Said R, Hong D S, Warneke C L, et al: P53 mutations in advanced cancers: clinical characteristics, outcomes, and correlation between progression-free survival and bevacizumab-containing therapy. Oncotarget 4:705-714, 2013
48. TCGA [Internet] [cited 2014 Jan 26] Available from: http://www.fda.gov/RegulatoryInformation/Guidances/default.htm
49. Komen Registry
50. Partridge A H, Norris V W, Blinder V S, et al: Implementing a breast cancer registry and treatment plan/summary program in clinical practice: a pilot program. Cancer 119:158-163, 2013
51. ASCO: Shaping the Future of Oncology:Envisioning Cancer Care in 2030 [Internet][cited 2014 Jan 26] Available from: http://www.asco.org/sites/default/files/shapingfuture-lowres.pdf
52. Leijen S, Beijnen J H: Abrogation of the G2 checkpoint by inhibition of Wee-1 kinase results in sensitization of p53-deficient tumor cells to DNA-damaging agents. Current Clinical . . . , 2010
53. Khalili J S, Yu X, Wang J, et al: Combination small molecule MEK and PI3K inhibition enhances uveal melanoma cell death in a mutant GNAQ- and GNAT 1-dependent manner. Clin Cancer Res 18:4345-4355, 2012
54. Wu X, Li J, Zhu M, et al: Protein kinase C inhibitor AEB071 targets ocular melanoma harboring GNAQ mutations via effects on the PKC/Erk1/2 and PKC/NF-τB pathways. Mol Cancer Ther 11:1905-1914, 2012
55. Dobashi Y, Watanabe Y, Miwa C, et al: Mammalian target of rapamycin: a central node of complex signaling cascades. Int J Clin Exp Pathol 4:476-495, 2011
56. Lebwohl D, Anak O, Sahmoud T, et al: Development of everolimus, a novel oral mTOR inhibitor, across a spectrum of diseases. Ann N Y Acad Sci 1291:14-32, 2013
57. Guo Y, Chekaluk Y, Zhang J, et al: TSC1 involvement in bladder cancer: diverse effects and therapeutic implications. J Pathol 230:17-27, 2013
58. Munoz J, Schlette E, Kurzrock R: Rapid response to vemurafenib in a heavily pretreated patient with hairy cell leukemia and a BRAF mutation. J Clin Oncol 31:e351-2, 2013
59. Haroche J, Cohen-Aubart F, Emile J-F, et al: Dramatic efficacy of vemurafenib in both multisystemic and refractory Erdheim-Chester disease and Langerhans cell histiocytosis harboring the BRAF V600E mutation. Blood 121:1495-1500, 2013
60. Kim K B, Cabanillas M E, Lazar A J, et al: Clinical responses to vemurafenib in patients with metastatic papillary thyroid cancer harboring BRAF(V600E) mutation. Thyroid 23:1277-1283, 2013
61. El-Osta H, Falchook G, Tsimberidou A, et al: BRAF mutations in advanced cancers: clinical characteristics and outcomes. PLoS ONE 6:e25806, 2011
62. Prahallad A, Sun C, Huang S, et al: Unresponsiveness of colon cancer to BRAF(V600E) inhibition through feedback activation of EGFR. Nature 483:100-103, 2012
63. Kandoth C, McLellan M D, Vandin F, et al: Mutational landscape and significance across 12 major cancer types. Nature 502:333-339, 2013
64. Jardim DLF, Conley A, Subbiah V: Comprehensive characterization of malignant phyllodes tumor by whole genomic and proteomic analysis: biological implications for targeted therapy opportunities. Orphanet J Rare Dis 8:112, 2013
65. Subbiah V, Brown R E, Buryanek J, et al: Targeting the apoptotic pathway in chondrosarcoma using recombinant human Apo2L/TRAIL (dulanermin), a dual proapoptotic receptor (DR4/DR5) agonist. Mol Cancer Ther 11:2541-2546, 2012
66. Subbiah V, Naing A, Brown R E, et al: Targeted morphoproteomic profiling of Ewing's sarcoma treated with insulin-like growth factor 1 receptor (IGF1R) inhibitors: response/resistance signatures. PLoS ONE 6:e18424, 2011

What is claimed is:

1. A method comprising
identifying multiple treatment plans for a cancer, wherein each of the multiple treatment plans comprises a strength of evidence for a basis of actionability;
rationalizing the multiple treatment plans based on the strengths of evidence of each of the multiple treatments.

2. A method as in claim 1
wherein the strength of evidence comprises clinically available drugs that can target a gene product that is differentially expressed in tumor versus normal elements.

3. A method as in claim 1
wherein the strength of evidence comprises data from a hypothetical case study or from a virtual patient.

4. A method as in claim 1, wherein rationalizing the multiple treatment plans comprise ranking the multiple treatment plans in the following order:
(i) treatment plans with drugs approved with companion diagnostic
(ii) treatment plans with therapeutic approaches outlined in treatment guidelines
(iii) treatment plans with clinical evidence indicating responsiveness to a drug class

5. A method for prioritizing treatment options for a cancer patient, the method comprising
identifying multiple biomarkers related to the cancer, wherein each of the multiple biomarkers comprises a strength of evidence for forming a basis of actionability for the cancer;
rationalizing the multiple biomarkers based on the strengths of evidence.

6. A method as in claim 5
wherein the strength of evidence comprises data from a hypothetical case study or from a virtual patient.

7. A method as in claim 5
wherein the strength of evidence of the biomarker comprises that the biomarker is configured for classifications and treatments of the cancer, or
wherein the strength of evidence of the biomarker comprises that the biomarker comprises measurable molecular or cellular elements linked to a health outcome or state.

8. A method as in claim 5
wherein the strength of evidence of the biomarker comprises that the biomarker is oncogenic or differentially expressed on tumor cells, and a treatment approach can be crafted that mitigates its oncogenic potential and/or permits the recognition and destruction of the tumor cells.

9. A method as in claim 5
wherein the strength of evidence of the biomarker comprises that the biomarker is clinically validated and has approved drugs that target it, or
wherein the strength of evidence of the biomarker comprises that the biomarker is clinically validated, and in widely accepted treatment guidelines.

10. A method as in claim 5
wherein the strength of evidence of the biomarker comprises that the biomarker is selected from biomarkers having the following factors: (i) clinical evidence suggesting responsiveness to one or more drugs or classes when the biomarker is present; (ii) the biomarker is direct target of approved and/or investigational drugs; (iii) the biomarker is part of a pathway that can be targeted by approved and/or investigational drugs; and (iv) the biomarker bears similarity to other biomarkers that are deemed actionable.

11. A method as in claim 5
wherein the strength of evidence of the biomarker comprises that the biomarker is a direct target of one or more approved drugs, and if targeted will interfere with malignant cell growth, or
wherein the strength of evidence of the biomarker comprises that the biomarker is functional in driving the malignancy and can be targeted by an approved drug, or
wherein the strength of evidence of the biomarker comprises that the biomarker is a direct component of an actionable pathway that can be targeted by an approved or investigational drug, or
wherein the strength of evidence of the biomarker comprises that the biomarker is part of a pathway that drives the malignancy and can be directly targeted by a drug, or
wherein the strength of evidence of the biomarker comprises that the biomarker is an indirect component of an actionable pathway that can be targeted by an approved or investigational drugs, or
wherein the strength of evidence of the biomarker comprises that the biomarker influences the activity or expression of other proteins that can be targeted by either an approved or investigational drug, or
wherein the strength of evidence of the biomarker comprises that the biomarker is homologous to an actionable biomarker that can be either directly or indirectly targeted by an approved or investigational drug.

12. A method as in claim 5
wherein the strength of evidence of the biomarker comprises that the presence of the biomarker can be targeted by a drug even if the biomarker is not itself functional in driving the malignancy.

13. A method as in claim 5
wherein the strength of evidence of the biomarker comprises that the biomarker expresses aberrantly or differentially in cancer cells and is exploited for targeted delivery.

14. A method as in claim 5
wherein the strength of evidence of the biomarker comprises that standard clinical treatment guidelines recommend that cancers with aberrations in the biomarker should or should not be treated with certain drugs and drug classes.

15. A method as in claim 5
wherein the strength of evidence of the biomarker comprises that available clinical data suggests that the biomarker is predictive of a therapeutic response,
wherein clinical data come from different phases, with Phase III studies providing the most robust evidence, and Phase I and Phase II studies or retrospective studies or registry data providing less definitive evidence.

16. A method as in claim 5
wherein the strength of evidence of a biomarker comprises that there is pre-clinical data indicating that an aberration or class of aberrations in the biomarker responds to a specific drug or drug class, or
wherein the strength of evidence of a biomarker comprises that there is clinical data on the therapeutic response of the biomarker within the context of a non-cancer disease.

17. A method as in claim 5, wherein rationalizing the multiple biomarkers comprises a ranking of the biomarkers in the following order:
(i) a biomarker for which approved drug treatments are available with one or more companion diagnostic,
(ii) a biomarker for which therapeutic approaches are available and outlined in treatment guidelines
(iii) a biomarker for which clinical evidence indicating responsiveness is available
(iv) a biomarker for which aberrations are used as inclusion criteria in clinical trials is available,
(v) a biomarker for which an increasing number of clinical trials seeking to enroll patients whose cancers harbor specific aberrations is available,
(vi) a biomarker for which pre-clinical evidence or clinical evidence indicating responsiveness to a drug class is available.

18. A method as in claim 5, wherein rationalizing the multiple biomarkers comprises a biomarker for which approved drug treatments are available with one or more companion diagnostics has a highest ranking.

19. A method as in claim 5, wherein rationalizing the multiple biomarkers comprises a biomarker for which pre-clinical evidence or clinical evidence indicating responsiveness to a drug class is available has a lowest ranking.

20. A method for prioritizing treatment options for a cancer patient, the method comprising
identifying multiple biomarkers related to the cancer, wherein each of the multiple biomarkers has a basis of actionability for the cancer, wherein the basis of actionability comprises a support level for a treatment option for the cancer;
rationalizing the treatment options based on the support levels of the biomarkers.
